(19) United States
(12) Patent Application Publication
(10) Pub. No.: US 2006/0070075 A1
(43) Pub. Date: Mar. 30, 2006

(54) Server-recorded macros and web application automation

(76) Inventor: Sergei Rodionov, Cupertino, CA (US)

Correspondence Address: PERKINS COIE LLP, P.O. BOX 2168, MENLO PARK, CA, 94026, US

(21) Appl. No.: 10/992,559

(22) Filed: Nov. 17, 2004

Related U.S. Application Data
(60) Provisional application No. 60/607,168, filed on Sep. 3, 2004.

(51) Int. Cl. G06F 9/46

(52) U.S. Cl. 718/102

(57) ABSTRACT

A method for remote servicing of a networked device includes recording one or more macros of a plurality of tasks in an HTML format that includes one or more generic networked device identifier parameters. The one or more generic networked device identifier parameters are then replaced with an identifier of the networked device. The one or macros are executed and a sequence of tasks results. The sequence of tasks is parsed into an XML format and sent to the networked device. The sequence of tasks is re-parsed into the HTML format and executed at the networked device.

### CROSS REFERENCE TO RELATED APPLICATIONS

This application claims the benefit of co-pending U.S. Provisional Patent Application No. 60/607,168 (attorney docket no. 59991-8001.US01) filed on Sep. 3, 2004, which is incorporated herein by reference.

### FIELD OF THE INVENTION

The present invention relates to automation of computer-related tasks within an information system and more particularly to creating and providing server-recorded macros for automating repetitive tasks in a web application.

### BACKGROUND OF THE INVENTION

There are many scenarios in which a user must repeat a task within a software application. By encapsulating complex sequences of actions into a macro project which can then be invoked by a single event, macros can save time, decrease errors, and permit autonomous operation freeing the user to perform other tasks.

Many recorder utilities have been created for automating user activities within desktop software applications, such as office productivity suites. With the development of the Internet, a new type of macro recorders has been introduced that enables the replay of repeatable sequences of user activities on the Internet, such as automatically downloading information from web sites. A typical Internet-enabled macro recorder utility relies on a web browser to intercept and capture user events generated by the web browser graphical user interface.

However, because of the distributed nature of web applications, desktop-based macro recorder utilities are not suited for automating user actions based on dynamic content. Specifically, recorded macros that include dynamic identifiers such as session keys, dynamic cookies and control flow parameters will fail to execute at a subsequent playback because such identifiers will no longer be valid within the scope of the user's current session. At least one potential limitation of user-recorded macros is that locally stored dynamic identifiers as well as web application API (application programming interface) in the form of URLs and parameter name-value pairs are not synchronized with the actual implementation on the server. Because neither dynamic data nor API is synchronized, any change in web application API will render the user recorded macro invalid.

Therefore, it would be advantageous to have a server-based macro recording technology that recognizes these potential problems by building macros from a series of HTTP requests received by the server and correctly executing the sequence of tasks upon playback.

One example of a web application that could benefit from a server-recorded macro is a web application that permits remote servicing of networked devices. As the digital age continues to evolve, more devices are being integrated with network connectivity as part of their design process. Network connectivity often includes modem, intranet, Internet and wireless access. Due to these connections to the outside world, the devices can be monitored and operated remotely and can increasingly also be serviced remotely.

FIG. 1 is an example of a prior art system 10 that includes a plurality of networked devices 20. Also included in system 10 is an Intranet 30, firewall 40, Internet 50, modems 60 and 70 and a remote service computer 80. Networked devices 20 are coupled to the Intranet 30 that is in turn connectively coupled to the firewall 40 and Internet 50. Networked devices 20 can connect to the service computer 80 by way of the Internet 50 or by modems 60 and 70. Some examples of networked devices include medical devices, factory equipment or any type of machine that supports bidirectional communications either directly or through a local computer system that interfaces with the device. To be remotely serviceable, a device must support two-way communications, for example, through TCP/IP. Some examples of devices without a workstation include a router, a printer and an automobile. At the same time, the system 10 enables web application users to interact with remotely located networked devices 20 by providing a set of interfaces for viewing and editing device information and sending operational commands to and receiving responses from the networked devices 20.

FIG, 2 is a prior art flowchart 82 that illustrates how HTTP requests are processed by a web application system. After a begin operation, an HTTP request is received and parsed to create a task instance, at operations 84 and 86. The HTTP task is then executed at operation 88 and it is determined if there are any more HTTP requests to process, at operation 90. If yes, control is passed back to operation 84. Otherwise, flowchart 82 is completed. This method of individually parsing each HTTP request is inefficient as it is typically done manually.

During their operation, networked devices may generate both hardware and software-related service requests that can take the form of an HTTP request. Due to the constantly increasing complexity of application software running on each device, local technicians often do not possess the skills to locally service software-related issues, in which case service calls could be redirected to a remote service center. As the number of serviced networked devices increases, the required skillset, utilized by a service engineer, is often repeated on each service call creating a need for methods and systems that permit automation of repetitive service routines without requiring knowledge of a programming language. While much of the servicing of networked devices could be performed remotely, in practice, remote servicing is not fully realized due to present barriers.

### SUMMARY OF THE INVENTION

The present invention is described and illustrated in conjunction with systems, apparatuses, methods, and computer program products of varying scope. In addition to the aspects of the present invention described in this summary, further aspects of the invention will become apparent by reference to the drawings and by reading the detailed description that follows.

In general, in one aspect, this invention provides systems, methods and apparatus, including computer program products, implementing and using techniques for creating and providing server-recorded macros in web applications.

In accordance with an embodiment of the present invention, a method for recording a server-based macro includes parsing a plurality of HTTP requests; creating an instance of a simple task for each request; executing the task; serializing and storing the task in web application memory at least during the macro recording process and merging the plurality of stored tasks into a macro project. In response to a determination that the recorded macro project comprises dynamically defined parameters, values for the dynamically defined parameters are replaced with parameter placeholders that can be assigned every time the project is invoked for execution (a process called parameterization).

In another embodiment of this invention, HTTP requests are parsed, stored, and merged with the macro project incrementally as they are received by the web application whereas parameterization is invoked either upon completion of each merge operation or at the end of the macro recording session.

A method for producing a macro, in accordance with another embodiment of the present invention, includes turning on a recording means and submitting a series of HTTP requests representing web application tasks. The recording means is then turned off and dynamically determined parameters, in the macro project, are replaced with parameter placeholders. An advantageous implementation of this invention may include an always-on macro recorder, in which case users can merge into a macro project an arbitrarily sorted set of previously executed and stored simple tasks.

A method for automating remote servicing of networked devices, in accordance with a final embodiment of this invention, includes recording a macro project by executing web application tasks related to a selected networked device whereas device-specific dynamically defined parameters (such as device or resource identifiers) are replaced with parameter placeholders. The macro project then can be re-executed at any time for any compatible networked device whereas parameter placeholders are replaced with device-specific parameters resulting in a set of commands available for the device to download and execute.

In a preferred embodiment, a macro project can be serialized, stored, viewed, and edited in a self-described computer language, such as extensible Markup Language (XML).

Embodiments of the invention presented are exemplary and illustrative in nature, rather than restrictive. The scope of the invention is determined by the appended claims.

### BRIEF DESCRIPTION OF THE DRAWINGS

FIG. 1 is an example of a prior art system that includes a plurality of networked devices;

FIG. 2 is a prior art flowchart that illustrates how HTTP requests are processed by a web application system;

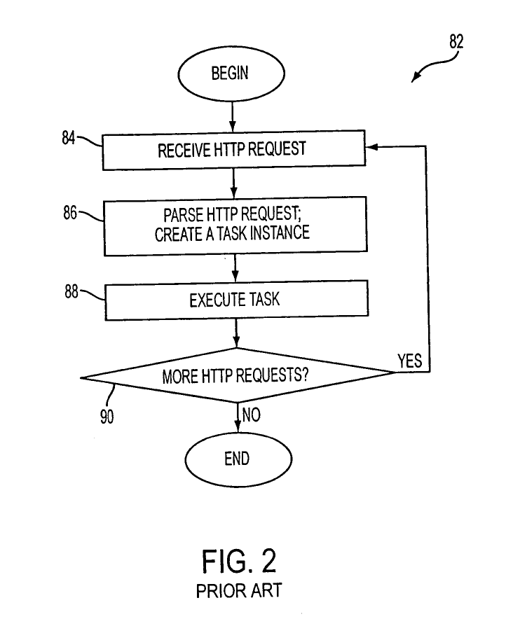

FIG. 3 illustrates a flowchart that shows a process for recording macros by a web application system wherein a macro project is created at the end of a macro recording session, in accordance with an embodiment of the present invention;

FIG. 4 illustrates a flowchart that shows a process for recording macros by a web application system wherein a macro project is created at the beginning of a macro recording session, in accordance with an embodiment of the present invention;

FIG. 5 illustrates a flowchart that shows a process for executing a recorded macro by a web application system, in accordance with an embodiment of the present invention;

FIG. 6 illustrates a flowchart that shows a process for executing a recorded macro by a remote servicing web application system, in accordance with an embodiment of the present invention;

FIG. 7 illustrates an exemplary HTML code that defines a task, in accordance with an embodiment of the present invention;

FIG. 8 illustrates an exemplary session flow for capturing a plurality of task instances, in accordance with an embodiment of the present invention;

FIG. 9 illustrates how various task instances are organized into a project, in accordance with an embodiment of the present invention;

FIG. 10 illustrates how a project is parameterized, in accordance with an embodiment of the present invention;

FIG. 11 illustrates an interface for merging two or more tasks into a macro for execution on a remote networked device, in accordance with an embodiment of the present invention;

FIG. 12 illustrates an interface for viewing and editing a task to be executed on a remote networked device, in accordance with an embodiment of the present invention;

FIG. 13 is a block diagram of an embodiment of a network;

FIG. 14 is a block diagram of an embodiment of a computer; and

FIGS. 15A and 15B illustrate an add configuration file interface and a project instance, in accordance with an embodiment of the present invention.

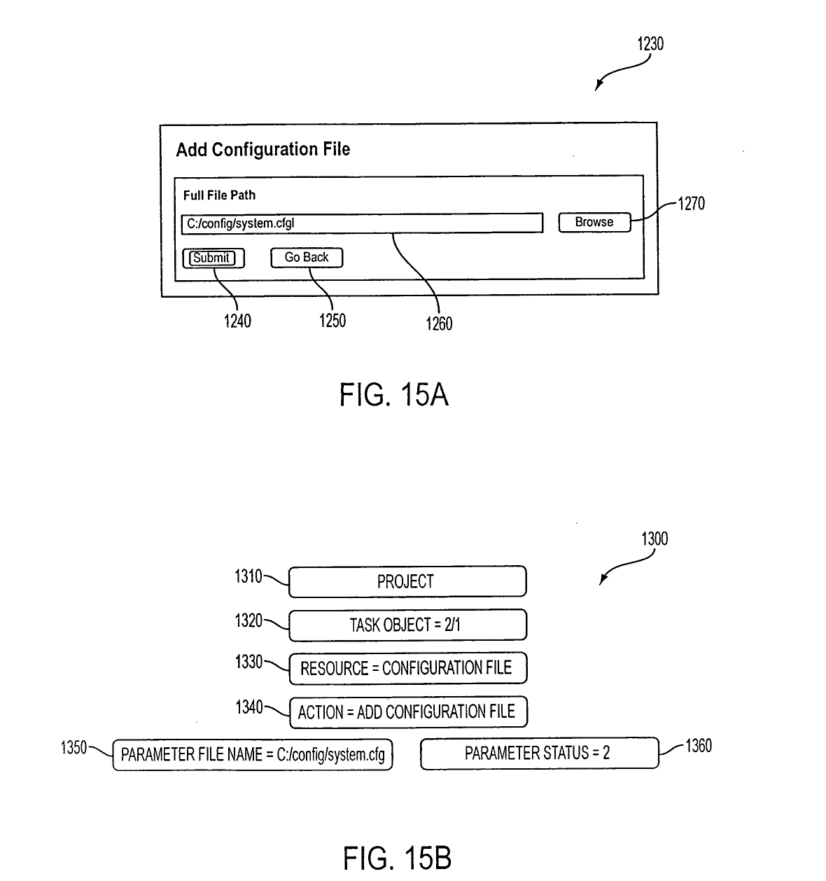

### DETAILED DESCRIPTION OF THE INVENTION

The present invention contemplates a variety of methods and systems for efficiently servicing remote networked devices. By capturing a set of individual task instantiations and making them non-specific, a library of parameterized macros can be built. These macros are then customized for a specific device and executed, resulting in a sequence of tasks. The sequence of tasks is efficiently sent to the remote networked device in an XML format. The sequence of tasks is then re-converted from XML and executed at the remote networked device. The parameters are typically used in place of device identifiers, file names, dates/times, operator name, etc. The macros must be parameterized for any value unique to a specific task instance.

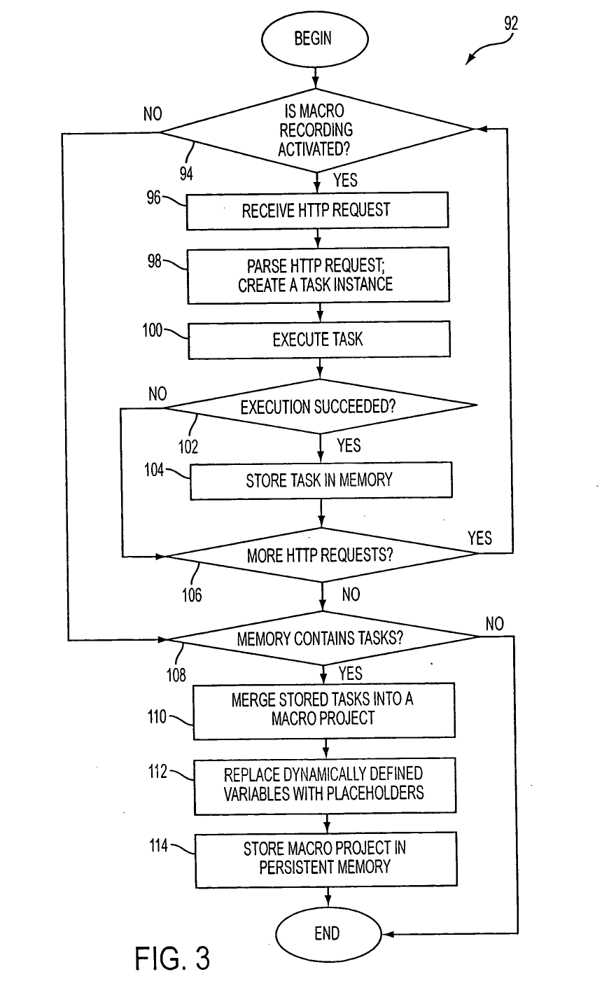

FIG. 3 illustrates a flowchart that shows a process 92 for recording macros by a web application system wherein a macro project is created at the end of a macro recording session, in accordance with an embodiment of the present invention. It is first determined if macro recording is turned on at decision point 94. If yes, an HTTP request is received, parsed and a task instance is created at operations 96 and 98. The task is then executed and it is determined if the task execution succeeded, at operations 100 and 102. If yes, the task is stored in memory at operation 104. If more HTTP requests need to be processed, control is passed back to decision point 94 via decision point 106. Similarly, if operation 100 failed, the failed task is not stored in memory and the next HTTP request is processed, if there are any left to process.

When all of the HTTP requests have been processed, it is determined if any tasks are contained in the volatile memory, at decision point 108. If yes, stored tasks are merged into a macro project, variables are replaced with placeholders and the macro project is stored in persistent memory, at operations 110, 112 and 114, respectively. Process 92 is now completed.

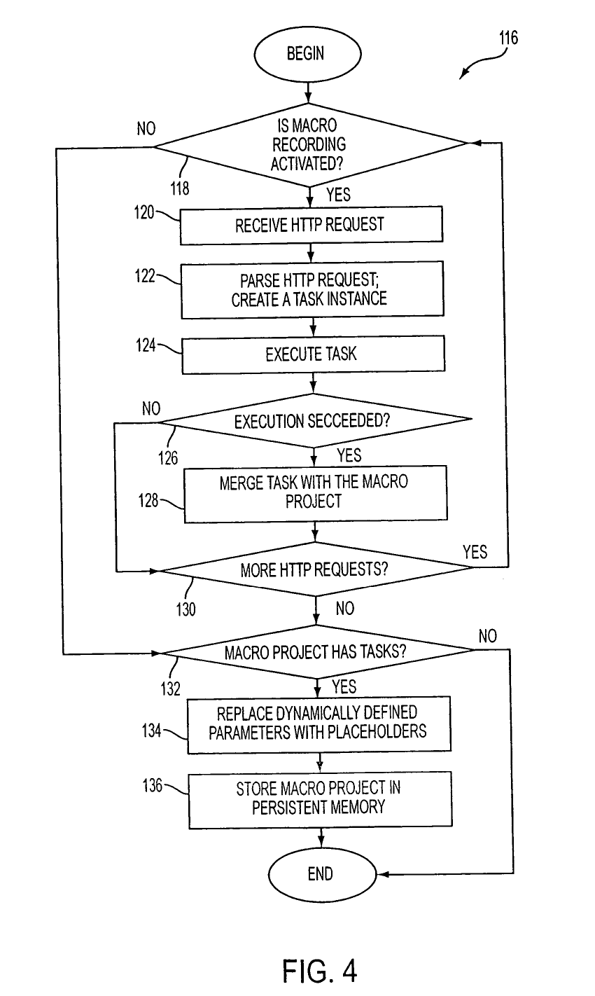

FIG. 4 illustrates a flowchart that shows a process 116 for recording macros by a web application system wherein a macro project is created at the beginning of a macro recording session, in accordance with an embodiment of the present invention. It is first determined if macro recording is turned on at decision point 118. If yes, an HTTP request is received and parsed and a task instance is created at operations 120 and 122. The task is then executed and it is determined if the task execution succeeded, at operations 124 and 126. If yes, the task is merged with a macro project at operation 128. If more HTTP requests need to be processed, control is passed back to decision point 118 via decision point 130. Similarly, if the task execution 126 failed, the failed task is not merged with the macro project and the next HTTP request is processed, if there are any left to process.

When all of the HTTP requests have been processed, it is determined if the macro project has any more tasks, at decision point 132. If yes, parameters are replaced with placeholders and the macro project is stored in persistent memory, at operations 134 and 136. If the macro project does not have any more tasks, process 116 is then completed.

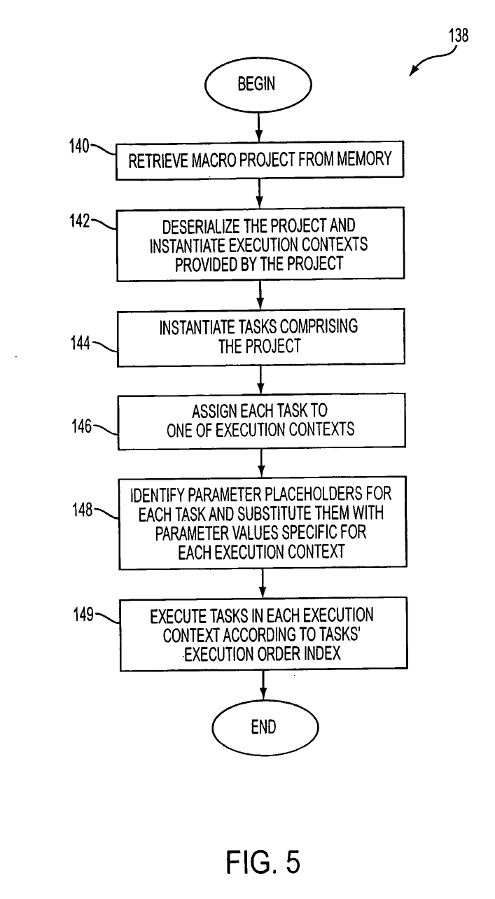

FIG. 5 illustrates a flowchart that shows a process 138 for executing a recorded macro by a web application system, in accordance with an embodiment of the present invention. A macro project is first retrieved from memory at operation 140. The macro project is then deserialized such that instantiate execution contexts are provided by the macro project, at operation 142. Tasks comprising the project are instantiated and assigned to one of the execution contexts via operations 144 and 146. Parameter placeholders are then identified for each task and are substituted with parameter values specific for each execution context, at operation 148. Finally, tasks are executed in progression according to the tasks' execution order index, at operation 149.

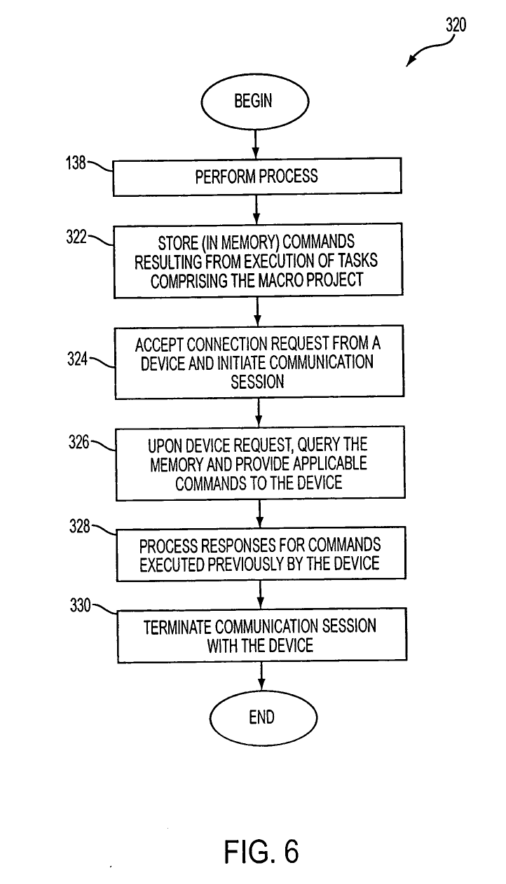

FIG. 6 illustrates a flowchart that shows a process 320 for executing a recorded macro by a remote servicing web application system, in accordance with an embodiment of the present invention. Process 138, of FIG. 5, is first executed and then operation 322 stores commands that resulted from execution of tasks that comprise the macro project. A connection request from a remote device is then accepted resulting in a communication session, at operation 324. When a device request is received, memory is queried and applicable commands are sent to the device, at operation 326. At operation 328, responses for commands are processed that were previously executed by the device. Finally, the communication session with the device is terminated, at operation 330.

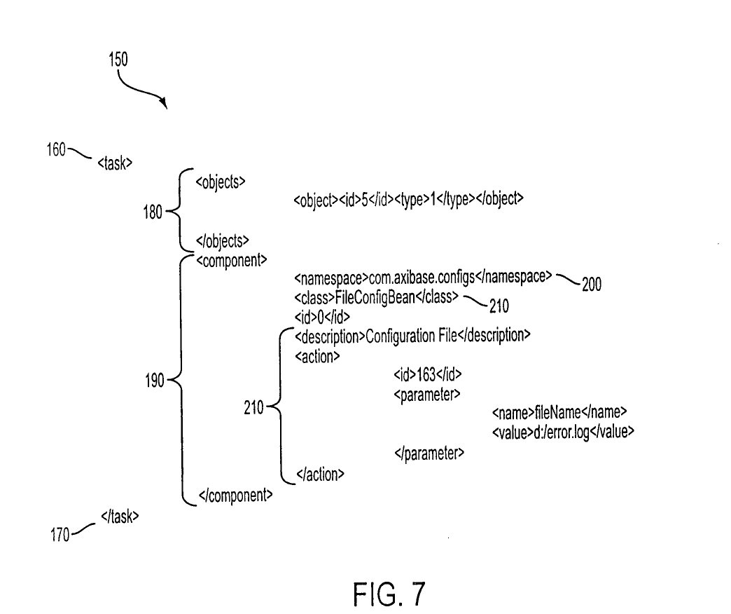

A macro needs to be built before it can be executed. This is accomplished by recording various keystrokes and actions performed by a service engineer relating to a task performed on a specific networked device or perhaps a plurality of networked devices, in an HTML format. An example of this can be seen in FIG. 7, which illustrates an exemplary HTML code 150 that defines a task, in accordance with an embodiment of the present invention. In this particular example, the beginning and end of the task definition is indicated at 160 and 170. A particular type of object is defined at section 180. Additionally, a component is defined at section 190. Some individual parts of the component section include defining a namespace at 200, defining a class is located at 210 and the specific task/action is defined in section 210.

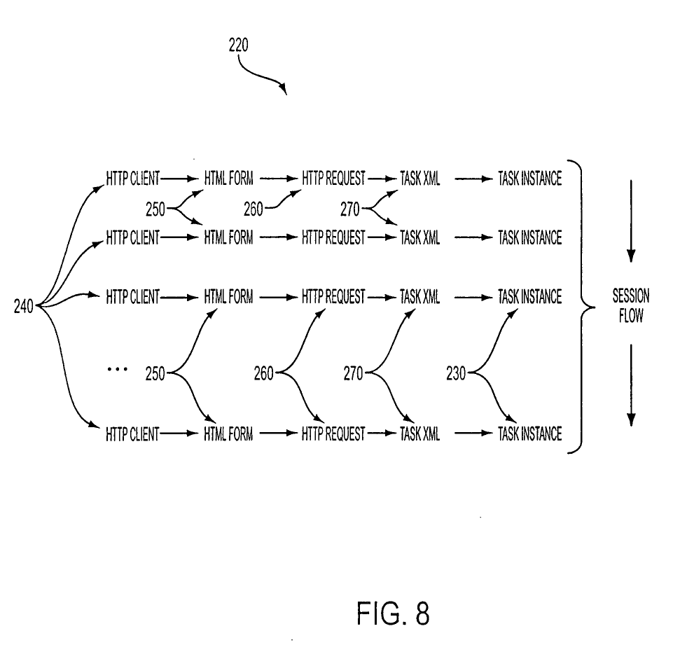

FIG. 8 illustrates an exemplary session flow 220 for capturing a plurality of task instances, in accordance with an embodiment of the present invention. These task instances are later implemented into a macro. As each task instance 230 occurs, an HTML client 240 records by generating HTML forms 250, HTTP requests 260 and task XMLs 270.

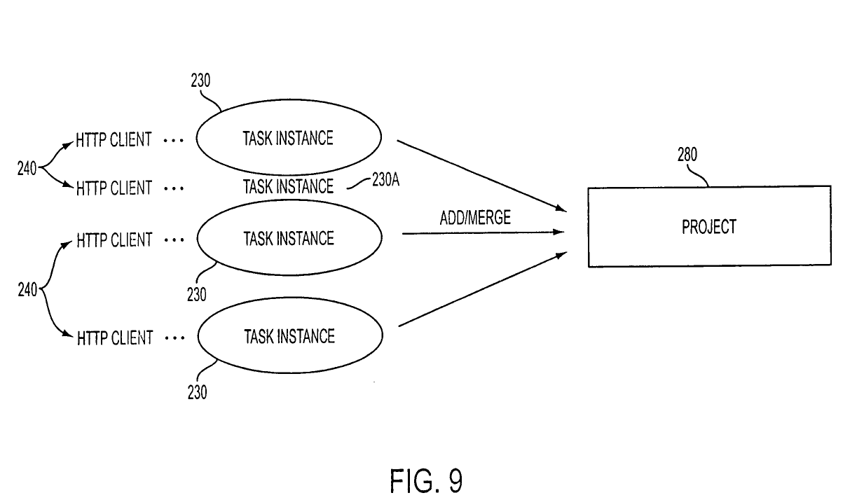

Once the task instances 230 are generated, they often need to be manipulated to remove extraneous portions. FIG. 9 illustrates how various task instances 230 are organized into a project, in accordance with an embodiment of the present invention. In this example, task instance 230A is deleted and the remaining task instances 230 are then merged into project 280. Project 280 forms the basis for the macro (not shown).

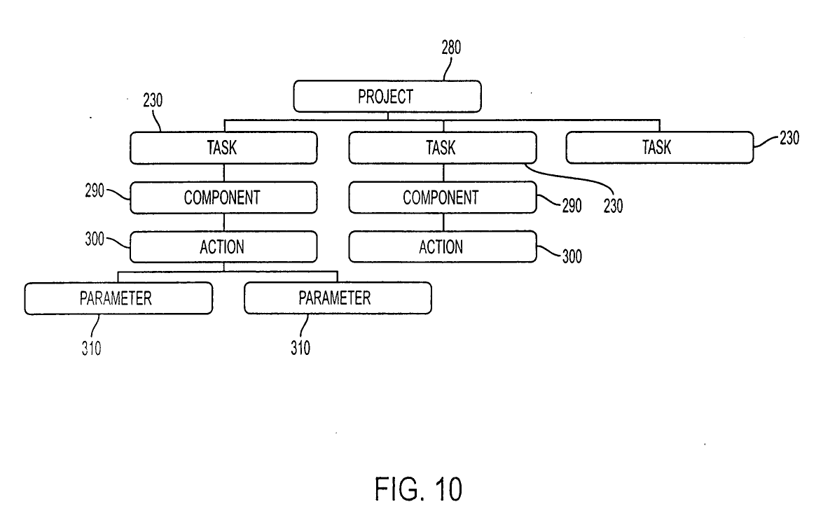

FIG. 10 illustrates how a project 280 is parameterized, in accordance with an embodiment of the present invention. As previously stated, the project 280 is made up of several tasks 230. Tasks 230 can be further defined by components 290 and actions 300. Actions 300 can then be made general by inserting appropriate parameters 310 in the place of device identifiers. When a specific device is later serviced, parameters 310 are filled in with appropriate values.

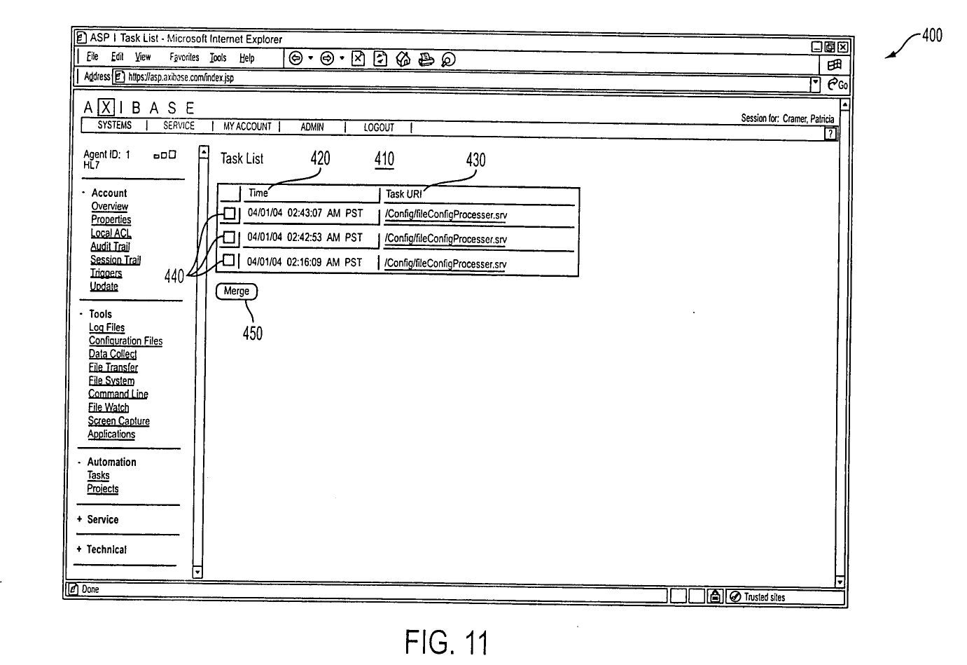

This next section will now describe various interfaces for facilitating the remote servicing of a networked device, in accordance with embodiments of the present invention. FIG. 11 illustrates an interface for merging two or more tasks into a macro for execution on a remote networked device, in accordance with an embodiment of the present invention. A task list 410, contained in an interface 400, includes a sub-list 420 of task instances and a sub-list 430 of task instance locations. Task instances can be merged into a macro by checking two or more of boxes 440 and then clicking a merge button 450.

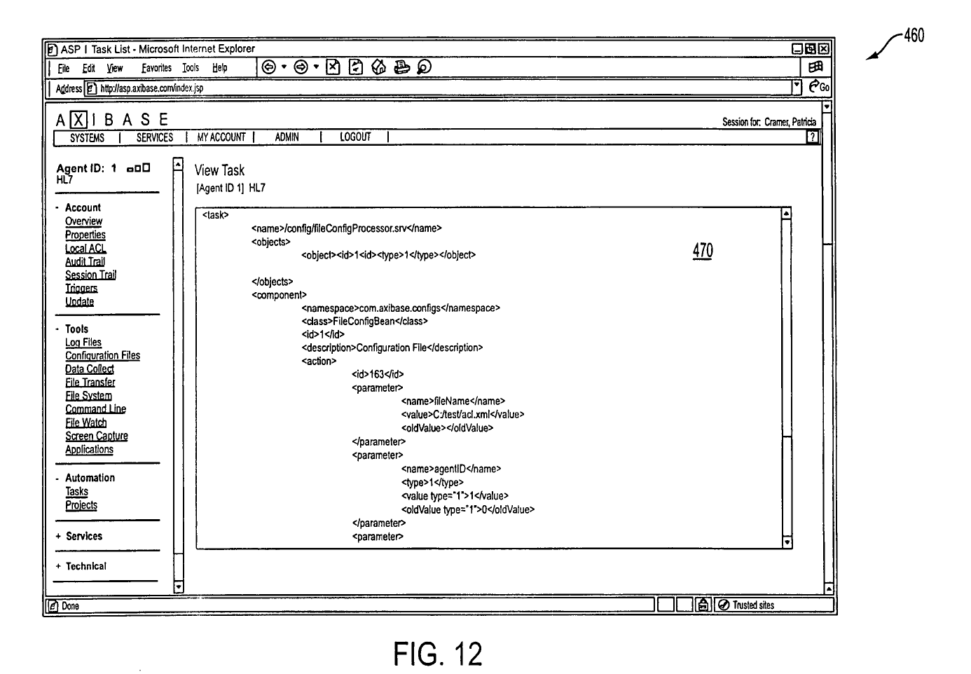

FIG. 12 illustrates an interface 460 for viewing and editing a task to be executed on a remote networked device, in accordance with an embodiment of the present invention. Interface 460 includes a window 470 that contains the task details. This is useful as details of a task can be reviewed and verified before they are executed at the remote networked device. If necessary, the task can be modified.

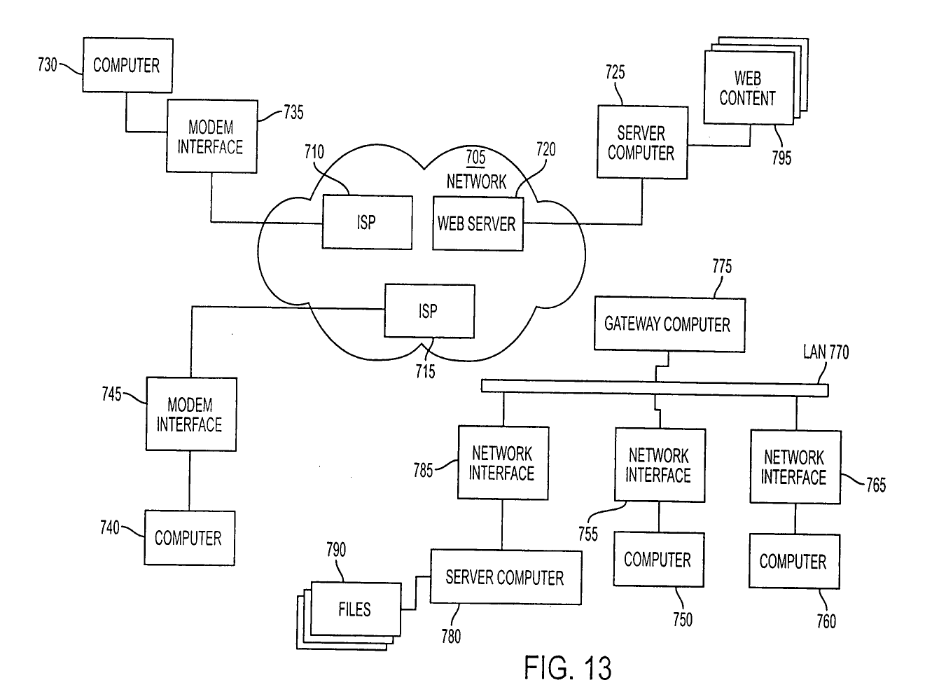

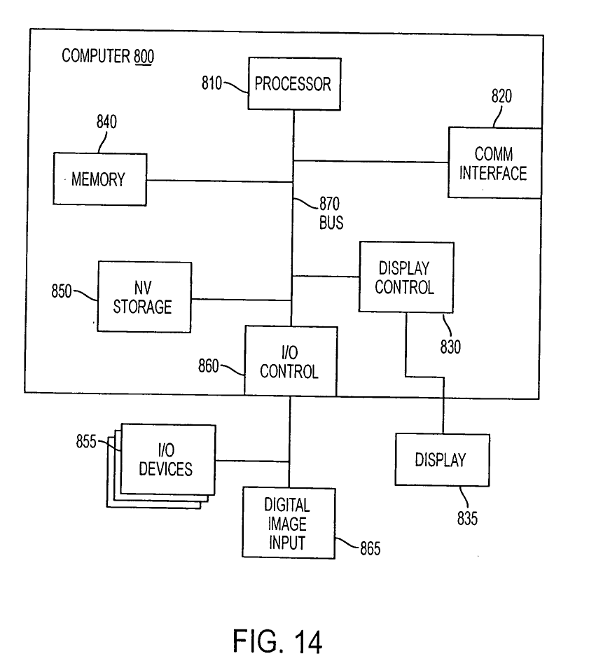

The following description of FIGS. 13-14 is intended to provide an overview of computer hardware and other operating components suitable for performing the methods of the invention described above, but is not intended to limit the applicable environments. Similarly, the computer hardware and other operating components may be suitable as part of the apparatuses of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 13 is a block diagram of an embodiment of a network 705, such as the Internet. The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art.

Access to the Internet 705 is typically provided by Internet service providers (ISP), such as ISPs 710 and 715. Users on client systems, such as client computer systems 730, 740, 750, and 760 obtain access to the Internet through the Internet service providers, such as ISPs 710 and 715. Access to the Internet allows users of the client computer systems to exchange information, receive and send e-mails, and view documents, such as documents which have been prepared in the HTML format. These documents are often provided by web servers, such as web server 720 which is considered to be “on” the Internet. Often these web servers are provided by the ISPs, such as ISP 710, although a computer system can be set up and connected to the Internet without that system also being an ISP.

The web server 720 is typically at least one computer system which operates as a server computer system and is configured to operate with the protocols of the World Wide Web and is coupled to the Internet. Optionally, the web server 720 can be part of an ISP which provides access to the Internet for client systems. The web server 720 is shown coupled to the server computer system 725 which itself is coupled to web content 795, which can be considered a form of a media database. While two computer systems 720 and 725 are shown in FIG. 13, the web server system 720 and the server computer system 725 can be one computer system having different software components providing the web server functionality and the server functionality provided by the server computer system 725 which will be described further below.

Client computer systems 730, 740, 750, and 760 can each, with the appropriate web browsing software, view HTML pages provided by the web server 720. The ISP 710 provides Internet connectivity to the client computer system 730 through the modem interface 735 which can be considered part of the client computer system 730. The client computer system can be a personal computer system, a network computer, a Web TV system, or other such computer system.

Similarly, the ISP 715 provides Internet connectivity for client systems 740, 750, and 760, although as shown in FIG. 13, the connections are not the same for these three computer systems. Client computer system 740 is coupled through a modem interface 745 while client computer systems 750 and 760 are part of a LAN. While FIG. 13 shows the interfaces 735 and 745 as generically as a “modem,” each of these interfaces can be an analog modem, ISDN modem, cable modem, satellite transmission interface (e.g. “Direct PC”), or other interfaces for coupling a computer system to other computer systems.

Client computer systems 750 and 760 are coupled to a LAN 770 through network interfaces 755 and 765, which can be Ethernet network or other network interfaces. The LAN 770 is also coupled to a gateway computer system 775 that can provide firewall and other Internet related services for the local area network. This gateway computer system 775 is coupled to the ISP 715 to provide Internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the Internet through the gateway system 775.

FIG. 14 is a block diagram of an embodiment of a computer that can be used as a client computer system or a server computer system or as a web server system. Such a computer system can be used to perform many of the functions of an Internet service provider, such as ISP 710. The computer system 800 interfaces to external systems through the modem or network interface 820. It will be appreciated that the modem or network interface 820 can be considered to be part of the computer system 800. This interface 820 can be an analog modem, ISDN modem, cable modem, token ring interface, satellite transmission interface (e.g. “Direct PC”), or other interfaces for coupling a computer system to other computer systems.

The computer system 800 includes a processor 810, which can be a conventional microprocessor such as an Intel Pentium microprocessor or Motorola Power PC microprocessor. Memory 840 is coupled to the processor 810 by a bus 870. Memory 840 can be dynamic random access memory (DRAM) and can also include static RAM (SRAM). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). The input/output devices 855 can include a keyboard, disk drives, printers, a scanner, and other input and output devices, including a mouse or other pointing device. The display controller 830 and the I/O controller 860 can be implemented with conventional well-known technology. A digital image input device 865 can be a digital camera which is coupled to an I/O controller 860 in order to allow images from the digital camera to be input into the computer system 800.

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to this embodiment, but it may lack some of the features shown in FIG. 14, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows®) from Microsoft Corporation of Redmond, Wash., and their associated file management systems. Another example of an operating system software with its associated file management system software is the LINUX operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some embodiments also relate to apparatus for performing the operations herein. This apparatus may be specially constructed for the required purposes, or it may comprise a general-purpose computer selectively activated or reconfigured by a computer program stored in the computer. Such a computer program may be stored (embodied) in a computer (machine) readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

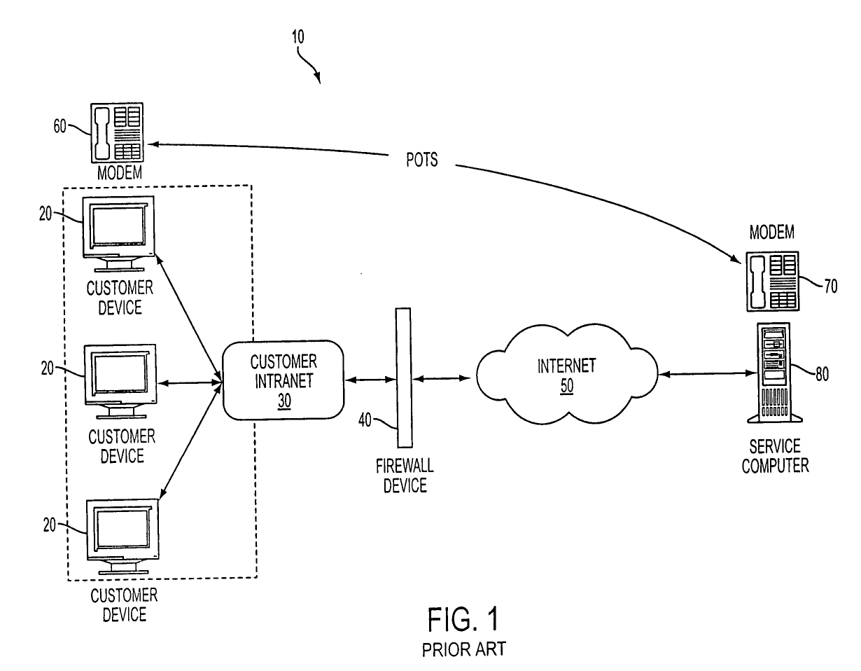

An exemplary Internet/web macro-flow will now be presented, partly in reference to FIGS. 1 5A and 15B which illustrate an add configuration file interface 1230 and a project instance 1300, in accordance with an embodiment of the present invention. First, a user fills out an HTML form and sends the HTML form by sending an HTTP request to an application server. This can be accomplished, for example, with file interface 1230. In this example, a configuration file is submitted by pressing button 1240. If the operation needs to be canceled, button 1250 can be accessed. Additionally, the file path 1260 can be added via button 1270.

A specific example of the HTML form is shown as follows:

<html>
<head>
<title>Add Configuration File</title>
</head>
<body>
<form method=“get” name=“theForm” action=“fileConfig.srv”>

<input type=“hidden” name=“object” value=“2|1”>
<input type=“hidden” name=“beanID” value=“0”>
<input type=“hidden” name=“status” value=“2”>
<input type=“text” name=“fileName” value=“”>
<input type=“submit” value=“Submit”>

</form>
</body>
</html>

Here, the HTML form has been filled out by the user, note that “C:/config/system.cfg” contained in file path 1260 is now also in this filled out HTML form:

<html>
<head>
<title>Add Configuration File</title>
</head>
<body>
<form method=“get” name=“theForm” action=“fileConfig.srv”>

<input type=“hidden”name=“object”value=“2|1”>
<input type=hidden”name=“beanID”value=“0”>
<input type=“hidden”name=“status”value=“2”>

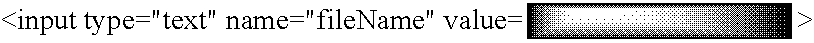

<input type=“submit”value=“Submit”>

</form>
</body>
</html>

After the HTML form is submitted to the application server, the HTTP request is parsed and the project instance 1300 is created. Instance 1300 includes various components such as an identifier 1310, a task 1320, a resource 1330, an action 1340 and various parameters 1350 and 1360.

After the instance 1300 is created, the application server executes and stores the project. The stored project can then be parameterized, merged into a larger macro project and the larger macro project can also be executed.

Various examples of XML encoded projects will now be presented. In this example, Projects A and B are not parameterized.

Project A:

```
<project>
  <task>
  <object><id>2</id><type>1</type></object>
    <resource>
```

```
<bean>
  <description>Configuration File</description>
</bean>
<action>
  <description>Add configuration file</description>
  <parameters>
    <fileName>
```

<value>C:/config/system.cfg</value>

```
    </fileName>
    <status>
```

<value>2</value>

```
    </status>
  </parameters>
</action>
```

```
    </resource>
  </task>
</project>
```

Project B:

```
<project>
  <task>
  <object><id>2</id><type>1</type></object>
    <resource>
```

```
<bean>
  <description>File Watch Node</description>
</bean>
<action>
  <description>Add file watch node</description>
  <parameters>
    <fileName>
```

<value>C:/config </value>

```
    </fileName>
    <status>
```

<value>2</value>

```
    </status>
    <incremental>
```

<value>false</value>

```
    </incremental>
  </parameters>
</action>
```

```
    </resource>
  </task>
</project>
```

In this next example, XML encoded Projects A and B are parameterized.

Project A:

```
<project>
  <variables>
    <obj><id>2</id><type>1</type></obj>
    <dir>C:/config</dir>
    <file>system.cfg</file>
    <stat>2</stat>
  </variables>
  <task>
  <object>${obj}</object>
    <resource>
```

```
<bean>
  <description>Configuration File</description>
</bean>
<action>
  <description>Add configuration file</description>
  <parameters>
    <fileName>
```

<value>${dir}/${file}</value>

```
    </fileName>
    <status>
```

<value>${stat}</value>

```
    </status>
  </parameters>
</action>
```

```
    </resource>
  </task>
</project>
```

Project B:

```
<project>
  <variables>
    <obj><id>2</id><type>1</type></obj>
    <dir>C:/config</dir>
    <stat>2</stat>
  </variables>
  <task>
  <object>${obj}</object>
    <resource>
```

```
<bean>
  <description>File Watch Node</description>
</bean>
<action>
  <description>Add file watch node</description>
  <parameters>
    <fileName>
```

<value>${dir}</value>

```
    </fileName>
    <status>
```

<value>${stat}</value>

```
    </status>
    <incremental>
```

<value>false</value>

```
    </incremental>
  </parameters>
</action>
```

```
    </resource>
  </task>
</project>
```

In this last example, parameterized Projects A and B are merged:

```
<project>
  <variables>
    <obj><id>2</id><type>1</type></obj>
    <dir>C:/config</dir>
    <file>system.cfg</file>
    <stat>2</stat>
  </variables>
  <task>
  <object>${obj}</object>
<!-- former project A begins here -->
    <resource>
```

```
<bean>
  <description>Configuration File</description>
</bean>
<action>
  <description>Add configuration file</description>
  <parameters>
    <fileName>
```

<value>${dir}/${file}</value>

```
    </fileName>
    <status>
```

<value>${stat}</value>

```
    </status>
  </parameters>
</action>
```

```
    </resource>
<!-- former project A stops here -->
<!-- former project B begins here -->
    <resource>
```

```
<bean>
  <description>File Watch Node</description>
</bean>
<action>
  <description>Add file watch node</description>
  <parameters>
    <fileName>
```

<value>${dir}</value>

```
    </fileName>
    <status>
```

<value>${stat}</value>

```
    </status>
    <incremental>
```

<value>false</value>

```
    </incremental>
  </parameters>
</action>
```

```
    </resource>
<!-- former project B stops here -->
  </task>
</project>
```

This invention potentially allows for a very efficient remote servicing of networked devices. By taking advantage of XML, macros can easily be built and parameterized for a variety of tasks to be executed on the networked device.

While this invention has been described in terms of certain embodiments, it will be appreciated by those skilled in the art that certain modifications, permutations and equivalents thereof are within the inventive scope of the present invention. It is therefore intended that the following appended claims include all such modifications, permutations and equivalents as fall within the true spirit and scope of the present invention.

What is claimed is:

1. A method for remote servicing of a networked device comprising:
opening a connection between a remote server and a networked device;
selecting a task to be performed on the networked device;
executing an XML-encoded macro, at the remote server, resulting in a sequence of tasks; and
sending the sequence of events to the networked device, the sequence of tasks accomplishing the selected task.

2. The method as recited in claim 1 wherein the XML-encoded macro is based on a previous remote service event of the networked device.

3. The method as recited in claim 1 wherein the XML-encoded macro is parameterized to allow insertion of an identifier relating to the networked device.

4. The method as recited in claim 1 wherein the networked device is a networked medical device.

5. The method as recited in claim 1 wherein the connection is established by transparent application tunneling.

6. A system for remote servicing of a networked device comprising:
a networked device; and
a remote server connected to the networked device wherein the server executes an XML-encoded macro that results in a sequence of tasks to be sent to and executed at the networked device to perform some service on the networked device.

7. The system as recited in claim 6 wherein the XML-encoded macro is based on a previous remote servicing event of the networked device.

8. The system as recited in claim 6 wherein the XML-encoded macro is parameterized to allow insertion of an identifier relating to the networked device.

9. The system as recited in claim 6 wherein the networked device is a networked medical device.

10. The system as recited in claim 6 wherein the remote server and the networked device are connected by transparent application tunneling.

11. A method for remote servicing of a networked device comprising:
recording one or more macros of a plurality of tasks in an HTML format that includes one or more generic networked device identifier parameters;
replacing the one or more generic networked device identifier parameters with an identifier of the networked device;
executing the one or macros resulting in a sequence of tasks;
parsing the sequence of tasks into an XML format;
sending the sequence of tasks to the networked device;
re-parsing the sequence of tasks into the HTML format; and
executing the sequence of tasks at the networked device.

12. The method as recited in claim 11 wherein the sequence of tasks, in the XML format, encapsulates one or more simple object access protocol commands.

13. The method as recited in claim 11 wherein the networked device is a networked medical device.

14. The method as recited in claim 11 wherein the one or more macros form a project.

15. The method as recited in claim 14 wherein a plurality of projects form a library.

16. The method as recited in claim 11 wherein the sequence of events is sent on a transparent application tunneling connection.

17. A data structure for repairing a networked device comprising an HTML-encoded macro that contains one or more generic networked device identifier parameters.

18. The data structure as recited in claim 17 wherein the networked device is a networked medical device.

19. The data structure as recited in claim 17 wherein the HTML-encoded macro is executed and a sequence of tasks is generated.

20. The data structure as recited in claim 19 wherein the sequence of tasks is parsed into an XML-encoded macro for transmission to the networked device.

21. The data structure as recited in claim 20 wherein the sequence of tasks is re-parsed into the HTML-encoded macro after transmission and is executed at the networked device.

22. The data structure as recited in claim 20 wherein the sequence of events is transmitted via transparent application tunneling.

23. A method for creating a server-based macro comprising:
receiving a plurality of HTTP requests;
parsing the plurality of HTTP requests;
creating a plurality of task instances based on the plurality of parsed HTTP requests;
executing the plurality of task instances;
storing each task instance of the plurality of task instances that successfully completed;
merging the stored task instances into a project; and
parameterizing the project.

24. The method as recited in claim 23 wherein each http request of the plurality of HTTP requests and each task of the plurality of tasks are processed in a serial fashion.

25. The method as recited in claim 23 wherein each stored task instance of the plurality of task instances is incrementally merged into the project.

26. A method for creating a macro comprising:
turning on a recording means;
recording a plurality of HTTP requests that represent web application tasks into the macro;
turning off the recorded means; and
parameterizing the macro.

27. The method as recited in claim 26 wherein certain HTTP requests of the plurality of HTTP requests are removed before the macro is parameterized.

28. A method for automating a task in a web application comprising:
retrieving a macro project;
deserializing the macro project;
instantiating a plurality of execution contexts associated with the macro project;
instantiating a plurality of tasks;
assigning each task of the plurality of tasks to a corresponding execution context of the plurality of execution contexts;
identifying one or more parameter placeholders in each task of the plurality of tasks;
replacing the one or more parameter placeholders with a value associated with the corresponding execution context of the plurality of execution contexts; and
executing each task of the plurality of tasks according to a task execution order index.

29. The method as recited in claim 28 further comprising:
storing commands resulting from the executed tasks;
accepting a connection request from a remote networked device;
initiating a communication session with the remote networked device;
providing specific stored commands at a request from the remote networked device;
executing the specific stored commands at the remote networked device;
processing one or more responses generated by the executed specific stored commands; and
terminating the communication session.
